(19) United States
(12) Patent Application Publication
(10) Pub. No.: US 2007/0276539 A1
(43) Pub. Date: Nov. 29, 2007

(54) SYSTEM AND METHOD OF ROBOTICALLY ENGAGING AN OBJECT

(76) Inventors: Babak Habibi, North Vancouver (CA); Geoff Clark, Vancouver (CA); Mohammad Sameti, Coquitlam (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/754,218

(22) Filed: May 25, 2007

Related U.S. Application Data
(60) Provisional application No. 60/808,903, filed on May 25, 2006.

(51) Int. Cl. G06F 19/00

(52) U.S. Cl. 700/245

(57) ABSTRACT

Briefly described, one embodiment is a method for imprecisely engaging an object or tool, the method comprising capturing an image of an imprecisely-engaged object with an image capture device, processing the captured image to identify a pose of the imprecisely-engaged object, and determining a pose deviation based upon the pose of the imprecisely-engaged object and the pose of a corresponding ideally-engaged object.

### CROSS-REFERENCE TO RELATED APPLICATION

This application claims the benefit under 35 U.S.C. § 119(e) of U.S. Provisional Patent Application No. 60/808,903 filed May 25, 2006, where this provisional application is incorporated herein by reference in its entirety.

### BACKGROUND OF THE INVENTION

1. Field of the Invention

This disclosure generally relates to robotic systems, and more particularly, to robotic vision-based systems operable to engage objects or tools.

2. Description of the Related Art

There are various manners in which a robot system may engage an object, such as a tool or workpiece, and perform a predefined task or operation. To reliably and accurately perform the predefined task or operation, the robot must engage or otherwise be physically coupled to the object in a precisely known manner.

Some objects employ alignment or guide devices, such as jigs, edges, ribs, rings, guides, joints, or other physical structures such that, when mated with a corresponding part on the robot end effector, provide precise pose (alignment, position, and/or orientation) of the object with the robot end effector. For example, a portion of the engaging device of the end effector may employ guides of a known shape and/or alignment. As the robot end effector performs an engaging operation with the object, the guide forces or urges the engaged object into proper pose with the robot end effector.

However, such object engaging techniques have various drawbacks. In many applications, the object must be initially placed in at least an approximately known location and orientation so that the engaging operation at least allows the guides to initially contact their corresponding mating guide on the object within some tolerance level so that the guides are operative to force or urge the object into proper pose with the robot end effector.

For example, assume that the engaged object is a vehicle engine that is to be mounted on a vehicle chassis. Further assume that the chassis is moving along an assembly line. The robot system must accurately engage the vehicle engine, transport the vehicle engine to the chassis, and then place the vehicle engine into the chassis at its intended location. So long as the one or more guides enable the vehicle engine to be accurately engaged by the robot, and so long as the chassis pose is known, the vehicle engine will be accurately placed at the intended location.

However, if there is a gross initial misalignment of the vehicle engine, then the engaging operation will not be successful because the guides will not be able to force or urge the vehicle engine into proper pose with respect to the robot engaging device. Such a situation can be envisioned if the vehicle engine is initially oriented in a backwards position. When the robot engaging device initially engages the backwards-aligned vehicle engine, the guides will presumably not be in alignment and the engaging operation will fail or the vehicle engine will be mis-aligned with the vehicle chassis.

As another example of a significant deficiency in the art of robotic systems, a variety of different objects may each require their own unique end effector for an engagement process. Often, engagement of a particular object requires a specialty end effector uniquely matched for that object, particularly when the guiding means used to force the object into proper pose during the engaging operation is specific to that particular object. However, another different object engaged by the same robot device may likely require a different end effector that is matched for that object. Accordingly, different end effectors are required for engaging different types of objects. The use of different end effectors for different engagement operations adds a layer in expense, in that different end effectors are costly to design and fabricate, and adds an additional layer in expense, in that changing end effectors requires time and disrupts the overall robotic process.

Accordingly, although there have been advances in the field, there remains a need in the art for increasing engaging efficiency during robotic-based operations. The present disclosure addresses these needs and provides further related advantages.

### BRIEF SUMMARY OF THE INVENTION

A system and method for engaging objects using a robotic system are disclosed. Briefly described, in one aspect, an embodiment may be summarized as a method comprising capturing an image of an imprecisely-engaged object with an image capture device, processing the captured image to identify a pose of the imprecisely-engaged object, and determining a pose deviation based upon the pose of the imprecisely-engaged object and an ideal pose of a corresponding ideally-engaged object.

In another aspect, an embodiment may be summarized as a robotic system that imprecisely engages objects, comprising an engaging device operable to imprecisely engage an object, an image capture device operable to capture an image of the imprecisely-engaged object, and a control system communicatively coupled to the image capture device. The control system is operable to receive the captured image, process the captured image to identify a pose of at least one reference point of the imprecisely-engaged object, and determine a pose deviation based upon the pose of the identified reference point and a reference point pose of a corresponding reference point on an ideally-engaged object.

In another aspect, an embodiment may be summarized as a method for engaging objects with a robotic system, the method comprising processing a captured image of an imprecisely-engaged object to identify an initial pose of the imprecisely-engaged object, referencing the initial pose of the imprecisely-engaged object with a coordinate system, and determining a path of movement for the imprecisely-engaged object, wherein the path of movement begins at the initial pose for the imprecisely-engaged object and ends at an intended destination for the imprecisely-engaged object.

In another aspect, an embodiment may be summarized as a method for engaging objects with a robotic system, the method comprising capturing an image of a plurality of imprecisely-engaged objects with an image capture device, processing the captured image to determine a pose of at least one of the imprecisely-engaged objects with respect to a reference coordinate system, and determining a path of movement for the at least one imprecisely engaged object to an object destination based upon the identified pose.

In another aspect, an embodiment may be summarized as a method for engaging objects with a robotic system, the method comprising acquiring information about an imprecisely-engaged object, processing the acquired information to identify a pose of the imprecisely-engaged object, and determining a pose of the imprecisely-engaged object.

In another aspect, an embodiment may be summarized as a method for engaging objects with a robotic system, the method comprising capturing an image of an imprecisely-engaged object with an image capture device, processing the captured image to determine at least one object attribute of the imprecisely-engaged object, and determining the pose of the imprecisely-engaged object based upon the determined object attribute.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is an isometric view of a robot object engaging system according to one illustrated embodiment.

FIG. 2 is a block diagram illustrating an exemplary embodiment of the robot control system of FIG. 1.

FIG. 3 is an isometric view illustrating in greater detail a portion of the robot engaging device in the workspace of FIG. 1.

FIG. 4A is an isometric view illustrating an ideally-engaged object.

FIG. 4B is an isometric view illustrating an imprecisely-engaged object.

FIGS. 5 and 6 are flow charts illustrating various embodiments of a process for engaging objects.

FIG. 7 is an isometric view illustrating an exemplary embodiment of the robot object engaging system employing a stationary image capture device.

FIG. 8 is an isometric view illustrating an exemplary embodiment of the robot object engaging system comprising a robot control system, a first robot and a second robot that are operable to engage a plurality of objects.

### DETAILED DESCRIPTION OF THE INVENTION

In the following description, certain specific details are set forth in order to provide a thorough understanding of various embodiments. However, one skilled in the art will understand that the invention may be practiced without these details. In other instances, well-known structures associated with robotic systems have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open sense, that is as “including, but not limited to.”

The headings provided herein are for convenience only and do not interpret the scope or meaning of the claimed invention.

Overview of the Object Engaging System

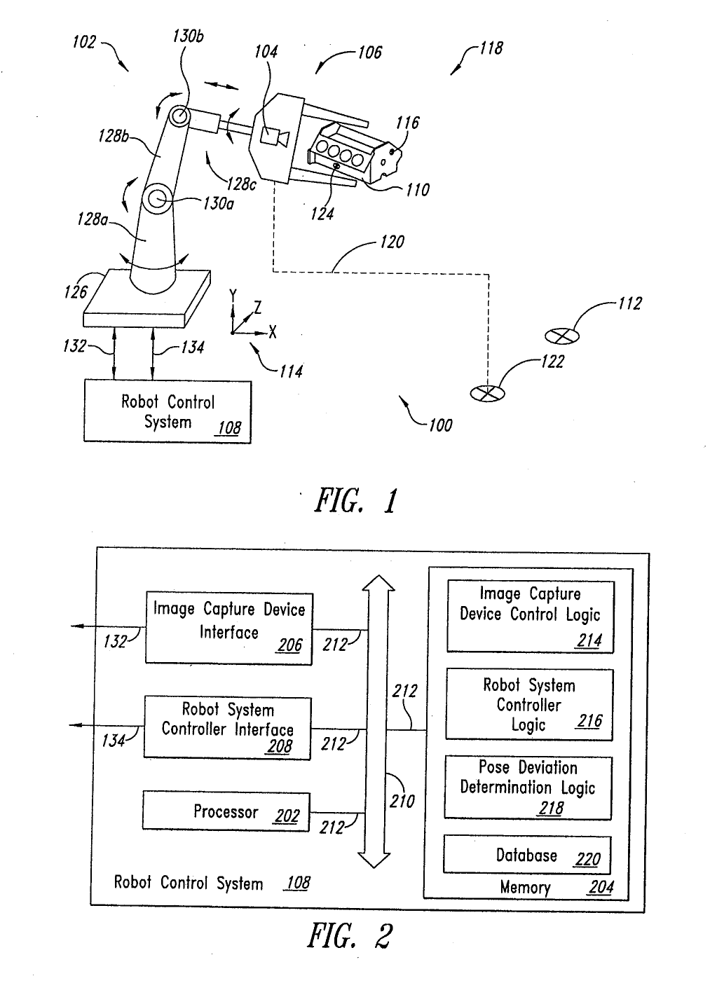

FIG. 1 is an isometric view of a robot object engaging system 100 according to one illustrated embodiment. The illustrated embodiment of object engaging system 100 comprises a robot device 102, at least one image capture device 104, an engaging device 106, and a robot control system 108.

The object engaging system 100 is illustrated as engaging object 110 with the engaging device 106. For convenience, the object 110 is illustrated as a vehicle engine. However, various embodiments of the robot object engaging system 100 are operable to engage any suitable object 110. Objects 110 may have any size, weight or shape. Objects may be worked upon by other tools or devices, may be moved to a desired location and/or orientation, or may even be a tool that performs work on another object.

For convenience, in the simplified example of FIG. 1, the engaging device 106 is illustrated as a very simple engaging apparatus. Embodiments of the object engaging system 100 may use any suitable type of engaging apparatus and/or method. For example, one embodiment of an engaging device 106 may be a simple grasping type of device, as illustrated in FIG. 1. The engaging device 106 may be more complex than illustrated in FIG. 1. For example, an engaging device 106 may have a plurality of engagement or grasping elements such as fingers or the like. Further, such engagement elements may be independently operable to adjust pose of the object.

Another non-limiting example includes a vacuum-based engaging device, which, when coupled to an object such as an electronic circuit or component, uses a vacuum to securely engage the object. Yet another non-limiting example includes a material-based engaging device such as Velcro, tape, an adhesive, a chain, a rope, a cable, a band or the like. Some embodiments may use screws or the like to engage object 110. Furthermore, the engagement need not be secure, such as when the object 110 is suspended from a chain, a rope, a cable, or the like. In such situations, embodiments periodically capture images of the engaged object 110 and revise the determined pose deviation accordingly. Other embodiments may employ multiple engaging devices 106. It is appreciated that the types and forms of possible engaging devices 106 are nearly limitless. Accordingly, for brevity, such varied engaging means can not be described herein. All such variations in the type, size and/or functionality of engaging devices 106 employed by various embodiments of a robot object engaging system 100 are intended to be included within the scope of this disclosure.

In an ideal object engaging and movement process, the object 110 is initially engaged by the engaging device 106 during the object engaging process. With the ideal object engaging process, the object 110 is precisely engaged, or ideally engaged, by the engaging device 106. That is, the ideally-engaged object is engaged such that the precise pose (location and orientation) of the engaged object 110, relative to the engaging device 106, is known by the robot control system 108. As noted above, conventional systems may use some type of alignment or guide means to force or urge the object 110 into proper pose with the engaging device 106 during the object engaging process.

Then, the robot object engaging system 100 performs an associated object movement process to move the object 110 to at least one final object destination 112. An object destination 112 may be a point in space, referenced by the reference coordinate system 114, where at least a reference point 116 on the object 110 will be posed (located and/or oriented) at the conclusion of the object movement process. The object destination point 112 is precisely known with respect to coordinate system 114. In some complex operations, a plurality of object destination points 112 may be defined such that the engaged object 110 is moved in a serial fashion from destination point to destination point during the process. In other operations, the destination point 112 may be moveable, such as when the conveyor system or moving palate is used in a manufacturing process. Thus, the path of movement is dynamically modified in accordance with movement of the destination point 112. Further, an adjustment of pose may itself be considered as a new destination point 112.

In some applications, a path of movement itself may be considered as equivalent to a destination point 112 for purposes of this disclosure. For example, if the engaged object 110 is a de-burring tool, the path of movement may be defined such that the de-burring tool is moved along a contour path of interest or the like to perform a de-burring operation on an object of interest. Once pose of the engaged de-burring tool is determined, the path of movement is determinable by the various embodiments of the robot object engaging system 100. However, for convenience and brevity, operation and function of the various embodiments are described within the context of an object destination 112. Accordingly, a path of movement (tantamount to plurality of relatively closely-spaced, serially-linked object destinations 112) is intended to be included within the scope of this disclosure.

In the ideal movement process, since the object 110 has been ideally engaged such that its pose is precisely known with respect to the reference coordinate system 114, the robot control system 108 may have been pre-taught and/or may precisely calculate a path of movement that the robot device 102 takes to precisely move the object 110 to the object destination 112. Accordingly, at the conclusion of the movement process, the object is located at the object destination at its intended or designed pose.

For example, the robot device 102 may precisely engage the vehicle engine (object 110), and then move the vehicle engine precisely to the object destination 112 such that the intended work may be performed on the vehicle engine. Thus, the illustrated vehicle engine may be secured to a vehicle chassis (not shown). As another non-limiting example, the robot object engaging system 100 may move the vehicle engine to the object destination 112 where other devices (not shown) may perform work on the vehicle engine, such as attaching additional components, painting at least a portion of the vehicle engine, or performing operational tests and/or inspections on one or more components of the vehicle engine.

It is appreciated that the exemplary example of engaging a vehicle engine and moving the vehicle engine is intended as an illustrative application performed by an embodiment of the robot object engaging system 100. The vehicle engine is representative of a large, heavy object. On the other hand, embodiments of a robot object engaging system 100 may be operable to engage and move extremely small objects, such as micro-machines or electronic circuit components. All such variations in size and/or functionality of embodiments of a robot object engaging system 100 are intended to be included herein within the scope of this disclosure.

An ideally-engaged object refers to an engaged object 110 whose initial pose is precisely known with reference to the known coordinate reference system 114, described in greater detail below, at the conclusion of the engaging process. As long as the object has been ideally engaged, the intended operations may be performed on, or be performed by, the ideally-engaged object.

It is appreciated that during a robotic process or operation, the reference coordinate reference system 114 is used to computationally determine the pose of all relevant structures in the workspace 118. Exemplary structures for which pose is determinable includes, but is not limited to, the object 110, one or more portions of the robot device 102, or any other physical objects and/or features within the workspace 118. The workspace 118 is the working environment within the operational reach of the robot device 102.

The reference coordinate system 114 provides a reference basis for the robot controller 108 to computationally determine, at any time, the precise pose of the engaging device 106 and/or engaged object 110. That is, the pose of the engaging device 106 and/or engaged object 110 within the workspace 118 is determinable at any point in time, and/or at any point in a process, since location and orientation information (interchangeably referred to herein as pose) is referenced to the origin of the reference coordinate system 114.

In the above-described ideal engaging and movement process, pose of an ideally-engaged object is known or determinable since pose of the engaging device 106 is precisely known. That is, since the pose of the engaging device 106 is always determinable based upon information provided by the components of the robot device 102 (described in greater detail below), and since the relationship between an ideally-engaged object and the engaging device 106 is precisely known, the “ideal pose” of the an ideally-engaged object is determinable with respect to the origin of the coordinate system 114.

Once the relationship between the precisely known pose of the ideally-engaged object 110 and the object destination 112 are known, the robot controller 108 determines the path of movement of the object 110 such that the robot device precisely moves the object 110 to the object destination 112 during an object movement process.

However, if the initial pose of the engaged object 110 is not precisely known with respect to the origin of the coordinate system 114, the robot object engaging system 100 can not precisely move the object 110 to the object destination 112 during the object movement process. That is, the robot device 102 can not move the object 110 to the object destination 112 in a precise manner in the absence of precise pose information for the object 110.

Embodiments of the object engaging system 100 allow the engaging device 106 to imprecisely engage an object 100 during the object engaging process. That is, the initial pose of the object 110 relative to the reference coordinate system 114 after it has been imprecisely engaged by the engaging device 106 is not necessarily known. Embodiments of the robot object engaging system 100 dynamically determine the precise pose of the engaged object 110 based upon analysis of a captured image of the object 110. Some embodiments dynamically determine an offset value or the like that is used to adjust a prior-learned path of movement. Other embodiments use the determined pose of the object 110 to dynamically determine a path of movement for the object 110 to the object destination 112. Yet other embodiments use the determined pose of the imprecisely-engaged object 110 to determine a pose adjustment such that pose of the object 110 is adjusted to an ideal pose before the start of, or during, the object movement process.

Dynamically determining the pose of object 110 can generally be described as follows. After object 110 has been imprecisely engaged by the engaging device 106, the image capture device 104 captures at least one image of the object 110. Since the spatial relationship between the image capture device 104 and the origin of the reference coordinate system 114 is precisely known, the captured image is analyzed to determine the precise pose of at least the reference point 116 of the object 110. Once the precise pose of at least the reference point 116 is determined, also referred to herein as a reference point pose, a path of movement that the robotic device 102 takes to move the object 110 to the object destination 112 is determinable.

If the reference point 116 is not visible by the image capture device 104, the pose determination may be based upon one or more visible secondary reference points 124 of the object 110. Pose of at least one visible secondary reference point 124 is determinable from the captured image data. The relative pose of the secondary reference point 124 with respect to the pose of the reference point 116 is known from prior determinations. For example, information defining the relative pose information may be based upon a model or the like of the object 110. Once the pose of at least one secondary reference point 124 is determined, the determined pose information of the secondary point 124 can be translated into pose information for the reference point 116. Thus, pose of object 110 is determinable from captured image data of at least one visible secondary reference point 124.

Exemplary Embodiment of an Object Engaging System

With reference to FIG. 1, the illustrated embodiment of the robot device 102 comprises a base 126 and a plurality of robot system members 128. A plurality of servomotors and other suitable actuators (not shown) of the robot device 102 are operable to move the various members 128. In some embodiments, base 126 may be moveable. Accordingly, the engaging device 106 may be positioned and/or oriented in any desirable manner to engage an object 110.

In the exemplary robot device 102, member 128a is configured to rotate about an axis perpendicular to base 126, as indicated by the directional arrows about member 128a. Member 128b is coupled to member 128a via joint 130a such that member 128b is rotatable about the joint 130a, as indicated by the directional arrows about joint 130a. Similarly, member 128c is coupled to member 128b via joint 130b to provide additional rotational movement. Member 128d is coupled to member 128c. Member 128c is illustrated for convenience as a telescoping type member that may be extended or retracted to adjust the position of the engaging device 106.

Engaging device 106 is illustrated as physically coupled to member 128c. Accordingly, it is appreciated that the robot device 102 may provide a sufficient number of degrees of freedom of movement to the engaging device 106 such that the engaging device 106 may engage object 110 from any position and/or orientation of interest. It is appreciated that the exemplary embodiment of the robot device 102 may be comprised of fewer, of more, and/or of different types of members such that any desirable range of rotational and/or translational movement of the engaging device 106 may be provided.

Robot control system 108 receives information from the various actuators indicating position and/or orientation of the members 128a-128c. Because of the known dimensional information of the members 128a-128c, angular position information provided by joints 130a and 130b, and/or translational information provided by telescoping member 128c, pose of any component of and/or location on the object engaging system 100 is precisely determinable at any point in time or at any point in a process when the information is correlated with a reference coordinate system 114. That is, control system 108 may computationally determine pose of the engaging device 106 with respect to the reference coordinate system 114.

Further, since the image capture device 104 is physically coupled to the robot device 102 at some known location and orientation, the pose of the image capture device 104 is known. Since the pose of the image capture device 104 is known, the field of view of the image capture device 104 is also known. In alternative embodiments, the image capture device 104 may be mounted on a moveable structure (not shown) to provide for rotational, pan, tilt, and/or other types of movement such that the image capture device 104. Thus, the image capture device 104 may be re-positioned and/or re-oriented in a desired pose to capture at least one image of at least one of the reference point 116, and/or one or more secondary reference points 124 in the event that the reference point 116 is not initially visible in the image capture device 104 field of view.

Preferably, an image Jacobian (a position matrix) is employed to efficiently compute position and orientation of members 128, image capture device 104, and engaging device 106. Any suitable position and orientation determination methods and systems may be used by alternative embodiments. Further, the reference coordinate system 114 is illustrated for convenience as a Cartesian coordinate system using an x-axis, an y-axis, and a z-axis. Alternative embodiments may employ other reference systems.

FIG. 2 is a block diagram illustrating an exemplary embodiment of the robot control system 108 of FIG. 1. Control system 108 comprises a processor 202, a memory 204, an image capture device interface 206, and a robot system controller interface 208.

For convenience, processor 202, memory 204, and interfaces 206, 208 are illustrated as communicatively coupled to each other via communication bus 210 and connections 212, thereby providing connectivity between the above-described components. In alternative embodiments of the robot control system 108, the above-described components may be communicatively coupled in a different manner than illustrated in FIG. 2. For example, one or more of the above-described components may be directly coupled to other components, or may be coupled to each other, via intermediary components (not shown). In some embodiments, communication bus 210 is omitted and the components are coupled directly to each other using suitable connections.

Image capture device control logic 214, residing in memory 204, is retrieved and executed by processor 202 to determine control instructions to cause the image capture device 104 to capture an image of at least one of the reference point 116, and/or one or more secondary reference points 124, on an imprecisely-engaged object 110. Captured image data is then communicated to the robot control system 108 for processing. In some embodiments, captured image data pre-processing may be performed by the image capture device 104.

Control instructions, determined by the image capture device control logic 214, are communicated to the image capture device interface 206 such that the control signals may be properly formatted for communication to the image capture device 104. For example, control instructions may control when an image of the object 110 is captured, such as after conclusion of the engaging operation. In some situations, capturing an image of the object before engaging may be used to determine a desirable pre-engaging pose of the engaging device 106. As noted above, the image capture device 104 may be mounted on a moveable structure (not shown) to provide for rotational, pan, tilt, and/or other types of movement. Accordingly, control instructions would be communicated to the image capture device 104 such that the image capture device 104 is positioned and/or oriented with a desired field of view to capture the image of the object 110. Control instructions may control other image capture functions such as, but not limited to, focus, zoom, resolution, color correction, and/or contrast correction. Also, control instructions may control the rate at which images are captured.

Image capture device 104 is illustrated as being communicatively coupled to the image capture device interface 206 via connection 132. For convenience, connection 132 is illustrated as a hardwire connection. However, in alternative embodiments, the robot control system 108 may communicate control instructions to the image capture device 104 and/or receive captured image data from the image capture device 104 using alternative communication media, such as, but not limited to, radio frequency (RF) media, optical media, fiber optic media, or any other suitable communication media. In other embodiments, image capture device interface 206 is omitted such that another component or processor 202 communicates directly with the image capture device 104.

Robot system controller logic 216, residing in memory 204, is retrieved and executed by processor 202 to determine control instructions for moving components of the robot device 102. For example, engaging device 106 may be positioned and/or oriented in a desired pose to engage object 110 (FIG. 1). Control instructions are communicated from processor 202 to the robot device 102, via the robot system controller interface 208. Interface 208 formats the control signals for communication to the robot device 102. Interface 208 also receives position information from the robot device 102 such that the pose of the robot device 102 and its components are determinable by the robot system controller logic 216.

Robot system controller interface 208 is illustrated as being communicatively coupled to the robot device 102 via connection 134. For convenience, connection 134 is illustrated as a hardwire connection. However, in alternative embodiments, the robot control system 108 may communicate control instructions to the robot device 102 using alternative communication media, such as, but not limited to, radio frequency (RF) media, optical media, fiber optic media, or any other suitable communication media. In other embodiments, robot system controller interface 208 is omitted such that another component or processor 202 communicates command signals directly to the robot device 102.

The pose deviation determination logic 218 resides in memory 204. As described in greater detail hereinbelow, the various embodiments determine the pose (position and/or orientation) of an imprecisely-engaged object 110 in the workspace 118 using the pose deviation determination logic 218, which is retrieved from memory 204 and executed by processor 202. The pose deviation determination logic 218 contains at least instructions for processing the received captured image data, instructions for determining pose of at least one visible reference point 116 and/or one or more secondary reference points 124, instructions for determining pose of the imprecisely-engaged object 110, and instructions for determining a pose deviation, and/or instructions for determining a modified path of movement, described in greater detail hereinbelow. Other instructions may also be included in the pose deviation determination logic 218, depending upon the particular embodiment.

Database 220 resides in memory 204. As described in greater detail hereinbelow, the various embodiments analyze captured image data to dynamically and precisely determine pose of the engaged object 110 (FIG. 1). Captured image data may be stored in database 220. Models of a plurality of objects or tools, one of which corresponds to the engaged object 110, reside in database 220. Any suitable model type and/or format may be used for the models. Models of the robot device 106, previously learned paths of motion associated with various tasks performed by the robot device 106, object and/or tool definitions, may also reside in database 220.

It is appreciated that the above-described logic, captured image data, and/or models may reside in other memory media in alternative embodiments. For example, image capture data may be stored in another memory or buffer and retrieved as needed. Models of object, tools, and/or robot devices may reside in a remote memory and be retrieved as needed depending upon the particular application and the particular robot device performing the application. It is appreciated that systems and methods of storage of information and/or models is nearly limitless. Accordingly, for brevity, such numerous possible storage systems and/or methods can not be conveniently described herein. All such variations in the type and nature of possible storage systems and/or methods employed by various embodiments of a robot object engaging system 100 are intended to be included herein within the scope of this disclosure.

Operation of an Exemplary Embodiment

Operation of an exemplary embodiment of the robot object engaging system 100 will now be described in greater detail. Assume that a robot's path of movement 120 for a particular operation has been learned prior to engaging the object 110. The robot's path of movement 120 corresponds to a path of travel for some predefined point on the robot device 106, such as the engaging device 106. In this simplified example, the engaging device 106 will traverse the path of movement 120 as the object 110 is moved through the workspace 118 to its object destination 112. Accordingly, in this simplified example, there is a corresponding known engaging device destination 122. The engaging device destination 122 corresponds to a predefined location where the engaging device 106 (or other suitable robot end effector) will be located when the reference point 116 of an ideally-engaged object 110 is at its object destination 112. The intended pose of object 110 at the object destination point 112 is precisely known with respect to coordinate system 114 because that is the intended, or the designed, location and orientation of the object 110 necessary for the desired operation or task to be performed.

Processor 202 determines control instructions for the robot device 102 such that object 110 (FIG. 1) is engaged. The various embodiments are operable such that the object 110 may be imprecisely engaged. The image capture device 104 is positioned and/or oriented to capture an image of the object 110. The image capture device 104 captures the image of the object 110 and communicates the captured image data to the robot control system 108.

The captured image data is processed to identify and then determine pose of a reference point 116 (and/or one or more visible secondary reference points 124). Since pose of the image capture device 104 is known with respect to the image coordinate system 114, pose of the identified reference point 116 (and/or secondary reference point 124) is determinable. Robot control system 108 compares the determined pose of the identified reference point 116 (and/or secondary reference point 124) with a corresponding reference point of the model of the object 110. Accordingly, pose of the object 110 is dynamically and precisely determined.

If the reference point 116 is not visible in the captured image, pose of the reference point 116 is determined based upon the determined pose of any visible secondary reference points 124. Robot control system 108 compares the determined pose of at least one identified reference secondary reference point 124 with a corresponding secondary reference point of the model of the object 110. The robot control system 108 translates the pose of the secondary reference point 124 to the pose of the reference point 116. In alternative embodiments, pose of the object 110 is determined directly from the determined pose of the secondary reference point 124. Accordingly, pose of the object 110 is dynamically and precisely determined.

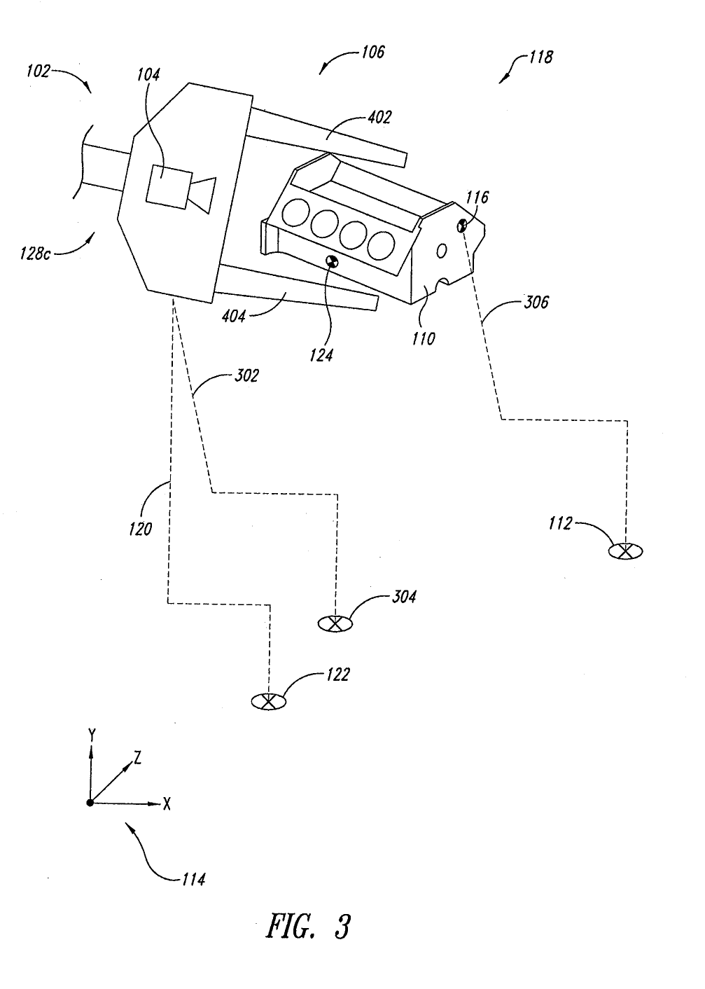

Any suitable image processing algorithm may be used to determine pose of the reference point 116 and/or one or more secondary reference points 124. In one application, targets having information corresponding to length, dimension, size, shape, and/or orientation are used as reference points 116 and/or 124. For example, a target may be a circle having a known diameter such that distance from the image capture device 104 is determinable. The target circle may be divided into portions (such as colored quadrants, as illustrated in FIGS. 1 and 3), or have other demarcations such as lines or the like, such that orientation of the target is determinable. Thus, pose of the a target is determinable once distance and orientation with respect to the image capture device 104 is determined. Any suitable target may be used, whether artificial such as a decal, paint, or the like, or a feature of object 110 itself.

In other embodiments, characteristics of the object 110 may be used to determine distance and orientation of the object 110 from the image capture device 104. Non-limiting examples of object characteristics include edges or features. Edge detection algorithms and/or feature recognition algorithms may be used to identify such characteristics on the object 110. The characteristics may be compared with known models of the characteristics to determine distance and orientation of the identified characteristic from the image capture device 104. Since pose of the identified characteristics is determinable from the model of the object, pose of the determined characteristics may be translated into pose of the object 110.

Based upon the determined pose of the object 110, in one exemplary embodiment, a pose deviation is determined. A pose deviation is a pose difference between the pose of an ideally-engaged object and the determined pose of the imprecisely-engaged object. Pose information for a model of an ideally-engaged object is stored in memory 204, such as the model data of the object in database 220. As described in greater detail below, once the robot control system 108 determines the pose deviation of the imprecisely-engaged object 110, control instructions can be determined to cause the robot device 102 to move the object 110 to the intended object destination 112.

FIG. 3 is an isometric view illustrating in greater detail a portion of robot device 102 in the workspace 118 of FIG. 1. As noted above, the illustrated robot's path of movement 120 is intended as a simplified example of a learned path or designed path for a particular robotic operation such that when an object 110 is ideally engaged (precisely engaged), movement of the engaging device 106 along a learned or designed path of movement 120 would position the ideally-engaged object 110 at a desired pose at the object destination 112.

It is appreciated that the illustrated robot's path of movement 120 is intended for illustrative purposes. Robot control system 108 (FIG. 1) may determine any suitable path of movement based upon the known pose of any part of the robot device 102 and/or for an engaged object 110. Also, as noted above, all or a portion of the path of movement 120 may itself be tantamount to the object destination 112 described herein. Accordingly, for brevity, such varied possible movement paths cannot be described herein. All such variations in the type and nature of a path of movement employed by various embodiments of a robot object engaging system 100 are intended to be included herein within the scope of this disclosure.

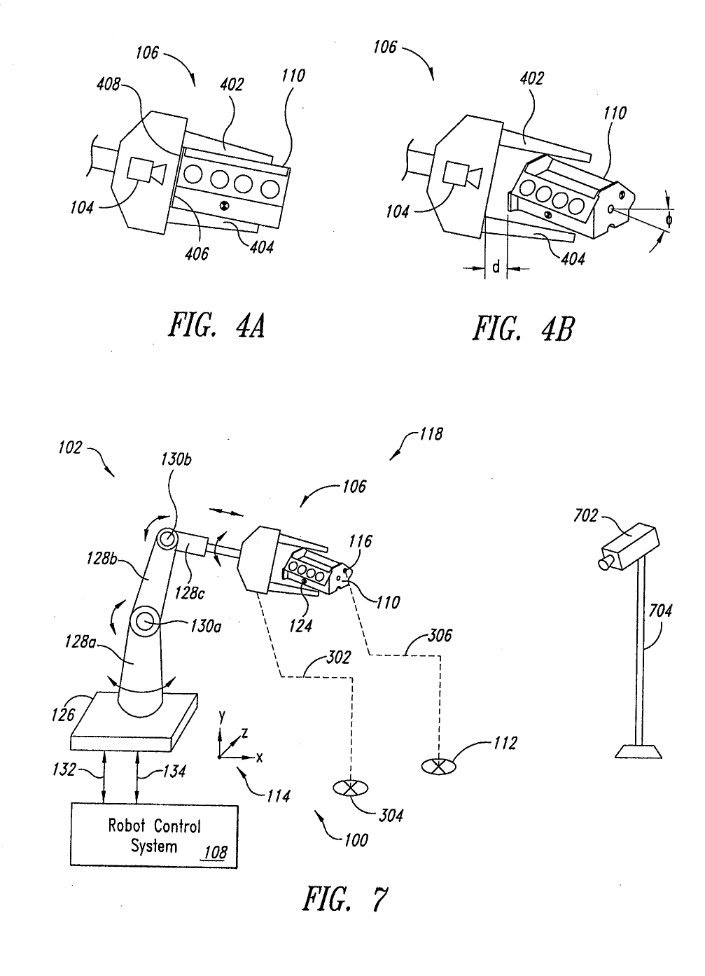

FIG. 4A is an isometric view illustrating an ideally-engaged object. That is, the engaging device 106 has engaged object 110 in a precisely known pose. For illustration purposes, the object 110 (vehicle engine) is in alignment with the engaging members 402 and 404 of the engaging device 106. Also, the end 406 of object 110 is seated against the backstop 408 of the engaging device 106. As noted above, conventional robotic engaging systems may use some type of alignment or guide means to force or urge the object 110 into an ideal pose with the engaging device 106.

FIG. 4B is an isometric view illustrating an imprecisely-engaged object 100. As illustrated, the object 110 (vehicle engine) is not in alignment with the engaging members 402 and 404 of the engaging device 106. The orientation of object 110 deviates from the ideal alignment illustrated in FIG. 4A by an angle φ. Also, the end 406 of object 110 is not seated against the backstop 408 of the engaging device 106. The object 110 is away from the backstop 408 by some distance d.

After the object 110 is imprecisely engaged, for example as illustrated in FIG. 4B, image capture device 104 captures an image of at least a portion of the object 110. The captured image includes at least an image of the reference point 116 and/or one or more secondary reference points 124. The captured image data is communicated to the robot control system 108.

In the event that the captured image does not include at least an image of the reference point 116 and/or one or more secondary reference points 124, the image capture device 104 may be moved and another image captured. Alternatively, an image from another image capture device 702 (FIG. 7) may be captured (having at least an image of the reference point 116 and/or one or more secondary reference points 124). Or, the object 110 may be re-engaged and another image captured with image capture device 104.

As noted above, the captured image data is processed to identify reference point 116 and/or one or more secondary reference points 124 of object 110. In some embodiments, pose of the identified reference point 116 and/or one or more secondary reference points 124 is then determined by comparing the determined pose of the reference point(s) 116, 124 with modeled information. Pose of the imprecisely-engaged object 110 may then be determined from the pose of the reference point(s) 116, 124.

A pose deviation of the reference point(s) 116, 124, or of the object 110, is then determined. For example, with respect to FIGS. 4A and 4B, an orientation deviation from the ideal alignment, corresponding to the angle φ, is determined. Also, a distance deviation corresponding to the distance that the end 406 of object 110 is away from the backstop 408 of the engaging device 106, corresponding to the distance d, is determined. The pose deviation in this example corresponds to the orientation deviation and the distance deviation.

Pose deviations may be determined in any suitable manner. For example, pose deviation may be determined in terms of a Cartesian coordinate system. Pose deviation may be determined based on other coordinate system types. Any suitable point of reference on the object 110 and/or the object 110 itself may be used to determine the pose deviation.

Further, pose deviation for a plurality of reference points 116, 124 may be determined. Determining multiple pose deviations may be used to improve the accuracy and reliability of the determined pose deviation. For example, the multiple pose deviations could be statistically analyzed in any suitable manner to determine a more reliable and/or accurate pose deviation.

It is appreciated that the approaches to referencing an object pose with a robotic device 102 and/or coordinate system 114 is nearly limitless. Accordingly, for brevity, such varied possible ways of determining object pose deviations are not described herein. All such variations in determining object pose deviations employed by various embodiments of a robot object engaging system 100 are intended to be included herein within the scope of this disclosure.

Returning to FIG. 3, the above-described robot's path of movement 120 is understood to be associated with an ideally-engaged object 110. For example, the vehicle engine illustrated in FIG. 4A is ideally engaged by the engaging device 106. When the robot device 102 is moved in accordance with the robot's path of movement 120, such that the engaging device 106 is moved to the engaging device destination 122, the ideally-engaged vehicle engine will be at the object destination 112 in an intended pose (location and orientation).

In contrast, if the imprecisely-engaged vehicle engine illustrated in FIG. 4A is moved by a conventional robot system, the object 110 will not be placed in a desired pose when moved in accordance with the robot's path of movement 120. That is, when the engaging device 106 is moved to the engaging device destination 122 in accordance with the learned or designed path of movement 120, the object 110 will not be positioned in the desired pose since it has be imprecisely engaged by the engaging device 106.

As noted above, embodiments of the object engaging system 100 have determined the above-described pose deviation. Accordingly, in one exemplary embodiment, a deviation work path 302 is determinable by offsetting or otherwise adjusting the ideal robot's path of movement 120 by the determined pose deviation. In the example of the imprecisely engaged vehicle engine illustrated in FIG. 3, the deviation work path 302 would be traversed such that the engaging device 106 is moved to a modified destination 304. Accordingly, the imprecisely engaged vehicle engine, moving along a path of movement 306, will be moved to the object destination 112 at the intended pose (location and orientation).

In another embodiment, the object deviation is used to dynamically compute an updated object definition. That is, once the actual pose of the imprecisely-engaged object 110 is determined from the determined pose deviation, wherein the actual pose of the imprecisely-engaged object 110 is defined with respect to a reference coordinate system 114 in the workspace 118, an updated path of movement 306 is directly determinable for the imprecisely-engaged object 110 by the robot control system 108. That is, the path of movement 306 for the imprecisely-engaged object 110 is directly determined based upon the actual pose of the imprecisely-engaged object 110 and the intended object destination 112. Once the path of movement 306 is determined, the robot control system 108 may determine movement commands for the robot device 102 such that the robot device 102 directly moves the object 110 to its intended destination 112.

In another embodiment, the determined pose of the imprecisely-engaged object 110 is used to determine a pose adjustment or the like such that the object 110 may be adjusted to an ideal pose. That is, the imprecise pose of the imprecisely-engaged object 110 is adjusted to correspond to the pose of an ideally-engaged object. Once the object pose is adjusted, the robot device 102 may continue operation using previously-learned and/or designed paths of movement. Pose adjustment may occur before the start of the object movement process, during the object movement process, at the end of the object movement process, at the conclusion of the object engagement process, or during the object engaging process.

As another illustrative example, assume that the object 110 is a tool. The tool is used to perform some work or task at destination 112. When the tool is ideally engaged, the robot control system is taught the desired task such that a predefined path of movement for the tool is learned. (Or, the predefined path of movement for the tool may be computationally determined.) This ideal predefined path corresponds to information about the geometry of the tool relative to the coordinate system 114, referred to as the tool definition. However, at some later point, an operation is undertaken which utilizes the tool that has been imprecisely engaged.

An image of the imprecisely-engaged tool is captured and processed to determine the above-described pose deviation. Based upon the determined pose deviation, the path of movement 306 (FIG. 3) for the tool is determined in some embodiments. In other embodiments, the tool definition is adjusted in accordance with the determined pose deviation. That is, the tool definition is updated to be true and/or correct for the current imprecisely-engaged tool (or object 110).

Some tools may be subject to wear or the like, such as a welding rod. Accordingly, pose of the end of the tool is unknown at the time of engagement by the robot device 106 (FIG. 1). Since the working portion of the tool (such as the end of the welding rod) is variable, the tool will be tantamount to an imprecisely engaged tool, even if precisely engaged, because of the variability in the working portion of the tool.

In some applications, similar tools may be used to perform the same or similar tasks. Although similar, the individual tools may be different enough that each tool will be imprecisely engaged. That is, it may not be practical for a conventional robotic system that employs guide means to be operable with a plurality of slightly different tools. One embodiment of the robot object engaging system 100 may imprecisely engage a tool type, and then precisely determine pose of the working end of the tool by processing a captured image as described herein. In some situations, the robot device 106 which engages an object may itself be imprecise. Its pose may be imprecisely known or may be otherwise imperfect. However, such a situation is not an issue in some of the various embodiments when pose of the image capture device 104 is known. That is, pose of the imprecisely-engaged object is determinable when pose of the image capture device 104 is determinable.

For convenience and brevity, image capture device 104 was described as capturing an image of an imprecisely-engaged object. In alternative embodiments, other sources of visual or non-visual information may be acquired to determine information such that pose of an imprecisely-engaged object is determinable. For example, a laser projector or other light source could be used to project detectable electromagnetic energy onto an imprecisely-engaged object such that pose of the imprecisely-engaged object is determinable as described herein. Other forms of electromagnetic energy may be used by alternative embodiments. For example, but not limited to, x-rays, ultrasound, or magnetic energy may be used. As a non-limiting example, a portion of a patient's body, such as a head, may be engaged and pose of the body portion determined based upon information obtained from a magnetic imaging device, such as a magnetic resonance imaging device or the like. Further, the feature of interest may be a tumor or other object of interest within the body such that pose of the object of interest is determinable as described herein.

In the various embodiments, captured image data is processed in real time, or in near-real time. Thus, the path of movement 306, or the deviation work path 302, is determinable in a relatively short time by the robot control system 108. Accordingly, the path of movement 306, or the deviation work path 302, are dynamically determined. Furthermore, the destination point that the engaged object is to be moved to (or a position of interest along the path of movement) need not be stationary or fixed relative to the robot device 102. For example, the chassis may be moving along an assembly line or the like. Accordingly, the destination point for the engine on the chassis would be moving.

Exemplary Processes of Dynamically Determining Deviation

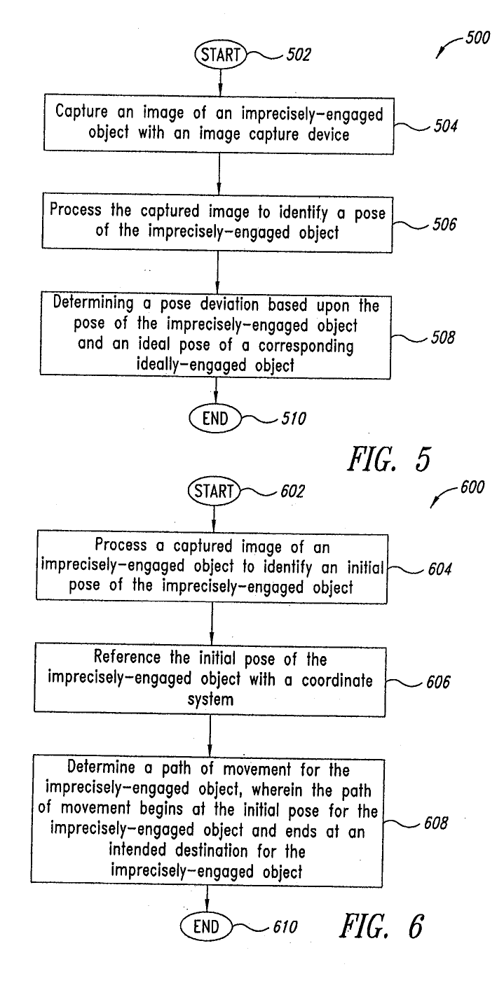

FIGS. 5 and 6 are flow charts 500 and 600, respectively, illustrating various embodiments of a process for moving objects using a robotic system employing embodiments of the object engaging system 100. The flow charts 500 and 600 show the architecture, functionality, and operation of various embodiments for implementing the logic 214, 216, and/or 218 (FIG. 2) such that such that an object deviation of an imprecisely-engaged object 110 (FIG. 1) is determined. An alternative embodiment implements the logic of charts 500 and/or 600 with hardware configured as a state machine. In this regard, each block may represent a module, segment or portion of code, which comprises one or more executable instructions for implementing the specified logical function(s). It should also be noted that in alternative embodiments, the functions noted in the blocks may occur out of the order noted in FIGS. 5 and 6, or may include additional functions For example, two blocks shown in succession in FIG. 5 and/or 6 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure.

The process illustrated in FIG. 5 begins at block 502. An image of an imprecisely-engaged object is captured with an image capture device at block 504. The captured image is processed to identify a pose of the imprecisely-engaged object at block 506. A pose deviation is determined based upon the pose of the imprecisely-engaged object and an ideal pose of a corresponding ideally-engaged object at block 508. The process ends at block 510.

The process illustrated in FIG. 6 begins at block 602. A captured image of an imprecisely-engaged object is processed to identify an initial pose of the imprecisely-engaged object at block 604. The initial pose of the imprecisely-engaged object is referenced with a coordinate system at block 606. A path of movement is determined for the imprecisely-engaged object, wherein the path of movement begins at the initial pose for the imprecisely-engaged object and ends at an intended destination for the imprecisely-engaged object at block 608. The process ends at block 610.

### ALTERNATIVE EMBODIMENTS

FIG. 7 is an isometric view illustrating an exemplary embodiment of the object engaging system 100 employing an image capture device 702 physically coupled to a remote structure, such as the illustrated stand 704. The image capture device 702 captures an image of at least a portion of the object 110. The captured image includes at least an image of the reference point 116 and/or one or more secondary reference points 124. The captured image data is communicated to the robot control system 108 such that the object deviation is determined.

The image capture device 702 is at some known location and orientation. Accordingly, the pose of the image capture device 702 is known. Since the pose of the image capture device 702 is known, the field of view of the image capture device 702 is also known. Thus, the image capture device 702 captures at least one image such that the pose of the reference point 116, and/or one or more secondary reference points 124, is determinable.

For convenience, a single image capture device 702 physically coupled to the stand 704 is illustrated in FIG. 7. In alternative embodiments, image capture device 702 may be physically coupled to another remote structure, such as a wall, ceiling, rail, beam, or other suitable structure. The image capture device 702 may be within, or outside of, the above-described workspace 118. In some embodiments, the image capture device 104 may be mounted on a moveable enclosure and/or mounted to a moveable structure, such as a track system, chain/pulley system or other suitable system. In other embodiments, image capture device 702 may be mounted on another robotic device. Movement allows the image capture device 702 to be positioned and oriented to capture an image of object 110 that includes at least an image of the reference point 116 and/or one or more secondary reference points 124.

In other embodiments, a plurality of image capture devices 702 may be employed. An image from a selected one of the plurality of image capture devices 702 may be used to dynamically determine pose of the imprecisely-engaged object 110. Multiple captured images from different image capture devices 702 may be used. Furthermore, one or more of the image capture devices 702 may be used in embodiments also employing the above-described image capture device 104 (FIGS. 1, 2, 4A. and 4B).

For convenience, the image capture device 104 illustrated in FIG. 1 is physically coupled to the engaging device 106. In alternative embodiments, the image capture device 104 may be physically located at any suitable location on the robot device 102 such that at least one image of the object 110 is captured. The captured image should have sufficient information to precisely determine the pose of the object 110. Thus, in one embodiment, the captured image should include the reference point 116 and/or one or more secondary reference points 124.

For convenience, a single image capture device 104 physically coupled to the engaging device 106 is illustrated in FIG. 1. In alternative embodiments, multiple image capture devices 104 may be used. For example, two image capture devices 104 could be physically coupled to the engaging device 106 to provide a stereoptic view of the object 110. Different views provided by a plurality of image capture devices 104 may be used to determine a plurality of poses for the object 110. Then, correlations may be performed to determine a “best” pose, or an “average” of the poses, of the imprecisely-engaged object 110. Thus, a more accurate and/or reliable pose deviation may be determined.

For convenience, only a single reference point on object 116 was described above. Alternative embodiments may employ multiple reference points 116 depending upon the nature of the object and/or the complexity of the task or operation being performed.

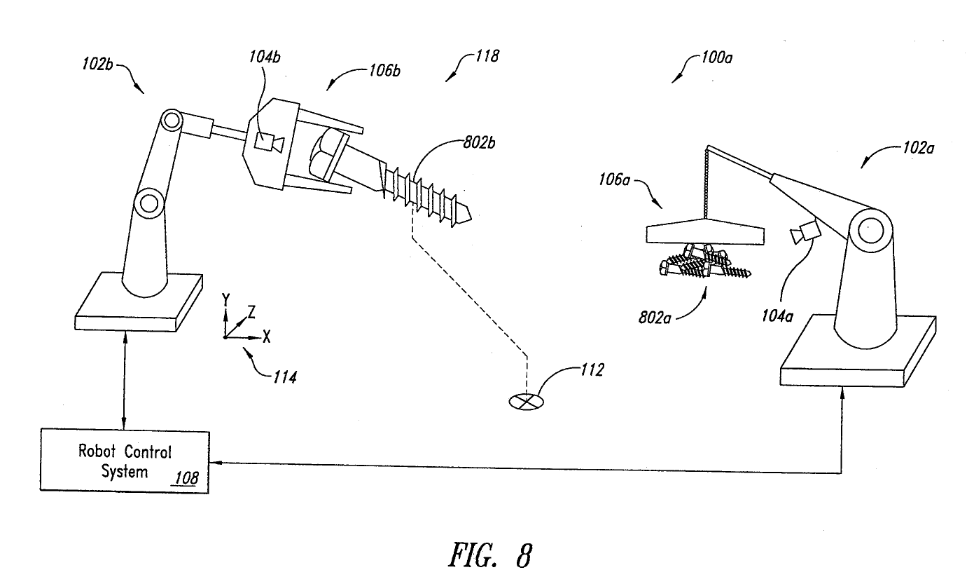

FIG. 8 is an isometric view illustrating an exemplary embodiment of the robot object engaging system 100a comprising a robot control system 108a, a first robot 102a and a second robot 102b that are operable to engage a plurality of objects 802a, 802b. The first robot device 102a comprises at least one image capture device 104a and an engaging device 106a. The second robot device 102b comprises at least one image capture device 104b and an engaging device 106b. The first robot 102a and the second robot 102b further comprise other components described above and illustrated in FIGS. 1-3, which are not described herein again for brevity.

For convenience, the engaging device 106a of the first robot 102a is illustrated as a magnetic type device that has engaged a plurality of metallic objects 802a, such as the illustrated plurality of lag bolts. In other embodiments, the engaging device 106a may be any suitable device operable to engage a plurality of objects.

Image capture device 104a captures at least one image of the plurality of objects 802a. Pose for at least one of the objects is determined as described hereinabove. In alternative embodiments, pose deviation may be determined as described hereinabove. In other alternative embodiments, pose and/or pose deviation for two or more of the engaged objects 802a may be determined. Once pose and/or pose deviation is determined for at least one of the plurality of objects 802a, one of the objects 802a is selected for engagement by the second robot device 102b.

Because pose and/or pose deviation has been determined for the selected object 802a with respect to the coordinate system 114, the second robot device 102b may move and position its respective engaging device 106b into a position to engage the selected object. The second robot device 102b may then engage the selected object with its engaging device 106b. The selected object may be precisely engaged or imprecisely engaged by the engaging device 102b. After engaging the selected object, the second robot device 102b may then perform an operation on the engaged object.

For convenience of illustration, the second robot device 102b is illustrated as having already imprecisely engaged object 802b and as already having moved back away from the vicinity of the first robot device 102a. In the various embodiments, the image capture device 104b captures at least one image of the object 802b. As described above, pose and/or pose deviation may then be determined such that the second robot device 102b may perform an intended operation on or with the engaged object 802b. For example, but not limited to, the object 102b may be moved to an object destination 112.

It is appreciated that alternative embodiments of the robot system 100a described above may employ other robot devices operating in concert with each other to imprecisely engage objects during a series of operations. Or, two or more robot engaging devices, operated by the same robot device or different robot device, may each independently imprecisely engage the same object and act together in concert. Further, the objects need not be the same, such as when a plurality of different objects are being assembled together or attached to another object, for example. Further, the second engaging device 106b was illustrated as engaging a single object 802b. In alternative embodiments, the second engaging device 106b could be engaging a plurality of objects.

In alternative embodiments of the robot engaging system 100a, the image capture devices 104a and/or 104b may be stationary, as described above and illustrated in FIG. 7. Further, one image capture device may suffice in alternative embodiments. The single image capture device may reside on one of the robot devices 102a or 102b, or may be stationary as described above.

It is appreciated that with some embodiments of the object engaging system 100, a single engaging device 102 (FIG. 1) may be operable to imprecisely engage one or more of a plurality of different types of objects and/or tools. For example, an object may be engaged from a bin or the like having a plurality of objects therein. The robot control system 108 is told or determines the object and/or tool type that is currently engaged. Pose is determined from a captured image of the imprecisely-engaged object and/or tool. The robot control system 108 compares the determined pose with an ideally-engaged model, thereby determining the above-described object pose deviation. Then, based upon the task that is to be performed upon the engaged object, or to be performed by the engaged tool (which may be one of many learned tasks for a plurality of different tool types), the robot control system 108 determines the path for movement of the object and/or tool such that the robot device 102 moves the object and/or tool to its respective object destination 122.

It is appreciated that after an object 110 (or tool) is moved to the object destination 122, and after the current operation or task is completed, another operation or task can be performed. The robot control system 108, knowing the next object destination associated with the next operation or task that is to be performed on the imprecisely-engaged object (or performed by the imprecisely engaged tool), using the previously determined object pose deviation, simply adjusts or otherwise modifies the next path of movement to correspond to a next deviation work path. Such continuing operations or tasks requiring subsequent movement of the imprecisely-engaged object or tool may continue until the object or tool is released from the engaging device 106.

Other means may be employed by robotic systems to separately or partially determine object pose. For example, but not limited to, force and/or torque feedback means in the engaging device 106 and/or in the other components of the robot device 102 may provide information to the robot control system 108 such that pose information regarding an engaged device is determinable. Various embodiments described herein may be integrated with such other pose-determining means to determine object pose. In some applications, the object engaging system 100 may be used to verify pose during and/or after another pose-determining means has operated to adjust pose of an engaged object.

For convenience and brevity, the above-described path of movement 120 was described as a relatively simple path of movement. It is understood that robotic paths of movement may be very complex. Paths of movement may be taught, learned, and/or designed. In some applications, a path of movement may be dynamically determined or adjusted. For example, but not limited to, anti-collision algorithms may be used to dynamically determine and/or adjust a path of movement to avoid other objects and/or structures in the workspace 118. Furthermore, pose of the engaged object 110 may be dynamically determined and/or adjusted.

For convenience and brevity, a single engaged object 110 was described and illustrated in FIGS. 1, 3, 4A-B, and 7. Alternative embodiments are operable to imprecisely engage two or more objects. For example, but not limited to, two or more objects from a bin or the like may be engaged. Embodiments are operable to capture an image that includes the two or more engaged objects. A pose deviation may be determined for one or more of the engaged objects. Or, an averaged, weighted, or other aggregated pose deviation for the engaged and visible objects may be determined. In some embodiments, a pose deviation may be determined based upon the pose of the two imprecisely-engaged objects and an ideal pose of a corresponding ideally-engaged object, and one of the two imprecisely-engaged objects may be selected based upon a pose of interest. In the various embodiments, a path of movement is determinable from the determined pose deviations.

In the above-described various embodiments, image capture device control logic 214, robot system controller logic 216, pose deviation determination logic 218, and database 220 were described as residing in memory 204 of the robot control system 108. In alternative embodiments, the logic 214, 216, 218, and/or database 220 may reside in another suitable memory medium (not shown). Such memory may be remotely accessible by the robot control system 108. Or, the logic 214, 216, 218, and/or database 220 may reside in a memory of another processing system (not shown). Such a separate processing system may retrieve and execute the logic 214, 216, and/or 218, and/or may retrieve and store information into the database 220.

For convenience, the image capture device control logic 214, robot system controller logic 216, and pose deviation determination logic 218 are illustrated as a separate logic modules in FIG. 2. It is appreciated that illustrating the logic modules 214, 216 and 218 separately does not affect the functionality of the logic. Such logic 214, 216 and 218 could be coded separately, together, or even as part of other logic without departing from the sprit and intention of the various embodiments described herein. All such embodiments are intended to be included within the scope of this disclosure.

In the above-described various embodiments, the robot control system 108 (FIG. 1) may employ a microprocessor, a digital signal processor (DSP), an application specific integrated circuit (ASIC) and/or a drive board or circuitry, along with any associated memory, such as random access memory (RAM), read only memory (ROM), electrically erasable read only memory (EEPROM), or other memory device storing instructions to control operation.

The above description of illustrated embodiments, including what is described in the Abstract, is not intended to be exhaustive or to limit the invention to the precise forms disclosed. Although specific embodiments of and examples are described herein for illustrative purposes, various equivalent modifications can be made without departing from the spirit and scope of the invention, as will be recognized by those skilled in the relevant art. The teachings provided herein of the invention can be applied to other object engaging systems, not necessarily the exemplary robotic system embodiments generally described above.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the control mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

Reference throughout this specification to “one embodiment” or “an embodiment” means that a particular feature, structure or characteristic described in connection with the embodiment is included in at least one embodiment of the present systems and methods. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

From the foregoing it will be appreciated that, although specific embodiments of the invention have been described herein for purposes of illustration, various modifications may be made without deviating from the spirit and scope of the invention. Accordingly, the invention is not limited except as by the appended claims.

These and other changes can be made to the present systems and methods in light of the above-detailed description. In general, in the following claims, the terms used should not be construed to limit the invention to the specific embodiments disclosed in the specification and the claims, but should be construed to include all power systems and methods that read in accordance with the claims. Accordingly, the invention is not limited by the disclosure, but instead its scope is to be determined entirely by the following claims.

1. A method for engaging objects with a robotic system, the method comprising:
capturing an image of an imprecisely-engaged object with an image capture device;
processing the captured image to identify a pose of the imprecisely-engaged object; and
determining a pose deviation based upon the pose of the imprecisely-engaged object and an ideal pose of a corresponding ideally-engaged object.

2. The method of claim 1, further comprising:
determining a pose of the imprecisely engaged object based upon the pose deviation and a reference coordinate system; and
determining a path of movement for the imprecisely engaged object from a current pose to an object destination based upon the determined pose.

3. The method of claim 1 wherein processing the captured image and determining the pose deviation comprises:
processing the captured image to identify a reference point pose for at least one reference point of the imprecisely-engaged object; and
determining the pose deviation based upon the reference point pose of the identified reference point and a corresponding reference point pose on a an ideally-engaged object.

4. The method of claim 3, further comprising:
determining a difference between the identified reference point on the imprecisely-engaged object and a model reference point on a known model of the imprecisely-engaged object, such that determining the pose deviation is based at least in part upon the difference between the identified reference point and the model reference point.

5. The method of claim 1, further comprising:
determining a deviation work path based upon the determined pose deviation, wherein the deviation work path corresponds to an ideal work path offset by the determined pose deviation.

6. The method of claim 5, further comprising:
moving the imprecisely-engaged object along the determined deviation work path.

7. The method of claim 1, further comprising:
determining an object pose of the imprecisely-engaged object based upon the determined pose deviation, wherein the object pose is defined with respect to a reference coordinate system; and
determining a path of movement for the imprecisely-engaged object, wherein the path of movement is determined based upon the object pose and the reference coordinate system.

8. The method of claim 7, further comprising:
moving the imprecisely-engaged object along the determined path of movement.

9. The method of claim 7, further comprising:
moving the imprecisely-engaged object along the determined path of movement to an object destination.

10. The method of claim 6 wherein the path of movement is further determined based upon a moveable object destination.

11. The method of claim 1 wherein determining the pose deviation comprises:
determining a distance deviation.

12. The method of claim 1 wherein determining the pose deviation comprises:
determining an orientation deviation.

13. The method of claim 1, further comprising:
imprecisely engaging an object with an engaging device.

14. The method of claim 1, further comprising:
imprecisely engaging a tool with an engaging device, wherein the imprecisely-engaged object is the imprecisely-engaged tool.

15. The method of claim 1, further comprising:
in response to determining the pose deviation, updating a tool definition for the tool.

16. A robotic system that engages objects, comprising:
an engaging device operable to imprecisely engage an object;
an image capture device operable to capture an image of the imprecisely-engaged object; and
a control system communicatively coupled to the image capture device, and operable to:
receive the captured image;
process the captured image to identify a pose of at least one reference point of the imprecisely-engaged object; and
determine a pose deviation based upon the pose of the identified reference point and a reference point pose of a corresponding reference point on an ideally-engaged object.

17. The system of claim 16 wherein the control system is operable to determining a pose of the imprecisely engaged object based upon the pose deviation and a robot coordinate system and to determining a path of movement for the imprecisely engaged object from a current pose to an object destination based upon the determined pose.

18. The system of claim 16 wherein the control system is operable to determine a difference between at least one identified reference point on the imprecisely-engaged object and a model reference point on a known model of the imprecisely-engaged object, such that determining the pose deviation is based at least in part upon the difference between the identified reference point and the model reference point.

19. The system of claim 16 wherein the image capture device is physically coupled to the engaging device.

20. The system of claim 16 wherein the image capture device is physically coupled to a remote structure.

21. The system of claim 16, further comprising:
a robot member operable to move the imprecisely-engaged object, and wherein the image capture device is physically coupled to the robot member.

22. A method for engaging objects with a robotic system, the method comprising:
processing a captured image of an imprecisely-engaged object to identify an initial pose of the imprecisely-engaged object;
referencing the initial pose of the imprecisely-engaged object with a coordinate system; and
determining a path of movement for the imprecisely-engaged object, wherein the path of movement begins at the initial pose for the imprecisely-engaged object and ends at an intended destination for the imprecisely-engaged object.

23. The method of claim 22, further comprising:
processing the captured image to identify an initial pose of at least one reference point of the imprecisely-engaged object; and
determining a pose deviation based upon the initial pose and a reference point pose of a corresponding reference point on an ideally-engaged object.

24. The method of claim 23 wherein processing the captured image to identify an initial pose of at least one reference point comprises:
processing the captured image to identify the initial pose of at least one secondary reference point; and
translating the initial pose of the at least one secondary reference point to the initial pose the reference point.

25. The method of claim 22, further comprising:
determining a difference between at least one identified reference point on the imprecisely-engaged object and a model reference point on a known model of the imprecisely-engaged object, such that determining the path of movement is based at least in part upon the difference between the identified reference point and the model reference point.

26. The method of claim 22 wherein determining the path of movement for the imprecisely-engaged object comprises:
determining a pose deviation based upon the initial pose and a reference point pose of a corresponding reference point on an ideally-engaged object; and
offsetting an ideal path of movement with an offset based upon the determined pose deviation.

27. The method of claim 22, further comprising:
moving the imprecisely-engaged object along the determined path of movement.

28. A system for engaging objects with a robotic system, comprising:
means for imprecisely engaging an object;
means for capturing an image of an imprecisely-engaged object with an image capture device;
means for processing the captured image to identify a pose of the imprecisely-engaged object; and
means for determining a pose deviation based upon the pose of the imprecisely-engaged object and an ideal pose of a corresponding ideally-engaged object.

29. The system of claim 28, further comprising:
means for moving the imprecisely-engaged object along a determined path of movement, wherein the determined path of movement is based upon the determined pose deviation.

30. The system of claim 28, further comprising:
means for adjusting an imprecise pose of the imprecisely-engaged object to an ideal pose.

31. A method for engaging objects with a robotic system, the method comprising:
capturing an image of a plurality of imprecisely-engaged objects with an image capture device;
processing the captured image to determine a pose of at least one of the imprecisely-engaged objects with respect to a reference coordinate system; and
determining a path of movement for the at least one imprecisely engaged object to an object destination based upon the identified pose.

32. The method of claim 31 wherein processing the captured image to identify a pose comprises:
processing the captured image to identify a reference point pose for at least one reference point of the at least one imprecisely-engaged object; and
determining the pose of at least one of the imprecisely-engaged objects based upon the reference point pose.

33. The method of claim 31, further comprising:
determining pose of at least two of the plurality of imprecisely-engaged objects;
selecting one of the at least two imprecisely-engaged objects based upon a pose of interest.

34. The method of claim 33, further comprising:
initially engaging the plurality of imprecisely-engaged objects with a first engaging device;
imprecisely engaging the selected one of the imprecisely-engaged objects with a second engaging device; and
processing a second captured image to determine a second pose of at least one of the imprecisely-engaged objects with respect to a reference coordinate system, such that determining the path of movement to the object destination for the selected imprecisely-engaged object is determined from the second pose.

35. A method for engaging objects with a robotic system, the method comprising:
acquiring information about an imprecisely-engaged object;
processing the acquired information to identify a pose of the imprecisely-engaged object; and
determining a pose of the imprecisely-engaged object.

36. The method of claim 35 wherein determining a pose of the imprecisely-engaged object is based upon an ideal pose of a corresponding ideally-engaged object and a reference coordinate system.

37. The method of claim 35 wherein acquiring information about the imprecisely-engaged object comprises:
acquiring ultrasound information.

38. The method of claim 35 wherein acquiring information about the imprecisely-engaged object comprises:
acquiring magnetic information.

39. The method of claim 38 wherein acquiring magnetic information comprises:
acquiring magnetic information with a magnetic resonant imaging device.

40. The method of claim 35 wherein acquiring information about the imprecisely-engaged object comprises:
acquiring laser energy information.

41. A method for engaging objects with a robotic system, the method comprising:
capturing an image of an imprecisely-engaged object with an image capture device;
processing the captured image to determine at least one object attribute of the imprecisely-engaged object; and
determining the pose of the imprecisely-engaged object based upon the determined object attribute.

42. The method of claim 41, further comprising:
determining a path of movement to an object destination for the imprecisely engaged object from the determined pose.

43. The method of claim 41 wherein processing the captured image and determining the pose deviation comprises:
processing the captured image to identify a reference point pose for at least one reference point of the imprecisely-engaged object; and
determining the pose based upon the reference point pose.

44. The method of claim 43, further comprising:
determining a difference between the identified reference point on the imprecisely-engaged object and a model reference point on a known model of the imprecisely-engaged object, such that determining the pose is based at least in part upon the difference between the identified reference point and the model reference point.

45. The method of claim 41, further comprising:
imprecisely engaging a tool with the engaging device, wherein the imprecisely-engaged object is the imprecisely-engaged tool, and wherein the determined pose is pose of the imprecisely-engaged tool.

46. The method of claim 41, further comprising:
in response to determining the pose, updating a tool definition for the tool.
